(19) United States
(12) Patent Application Publication
(10) Pub. No.: US 2024/0228889 A1
(43) Pub. Date: Jul. 11, 2024

(54) HYDROPROCESSING WITH INCREASED RECYCLE GAS PURITY

(71) Applicant: TOPSOE A/S, Kgs. Lyngby (DK)

(72) Inventors: Steven W. STUPIN, Orange, CA (US); Stefan ANDERSEN, Værløse (DK); Priyesh THAKKER, Missouri City, TX (US)

(73) Assignee: TOPSOE A/S, Kgs. Lyngby (DK)

(21) Appl. No.: 18/558,409

(22) PCT Filed: May 6, 2022
(86) PCT No.: PCT/EP2022/062337

§ 371 Date: Nov. 1, 2023

Related U.S. Application Data
(60) Provisional application No. 63/185,598, filed on May 7, 2021.

(30) Foreign Application Priority Data
Jul. 8, 2021 (EP) 21184518.5

(51) Int. Cl. C10G 5/04; C10G 5/06

(52) U.S. Cl. CPC C10G 5/04; C10G 5/06; C10G 2300/4006; C10G 2300/4012

(57) ABSTRACT

A process, a process plant and equipment for conversion of a feedstock rich in oxygenates to a hydrocarbon including directing the feedstock in combination with a recycle gas stream to a hydroprocessing step, to provide a two-phase hydroprocessed process stream including at least hydrogen, methane and hydrocarbons, combining a methane lean stream of hydrocarbons being liquid at ambient temperature, with a methane donor stream being either (i) the two-phase hydroprocessed process stream including methane or (ii) a gaseous stream derived from the two-phase hydroprocessed process stream by phase separation, to provide a multiple-phase combined stream, separating the multiple-phase combined stream into at least a hydrogen rich gas stream and a rich liquid hydrocarbon stream, in a desorption step desorbing an amount of methane from the rich liquid hydrocarbon stream, to provide a methane rich gas phase and a liquid product stream of hydrocarbons.

The present disclosure relates to a process for separation of hydrogen and methane, especially in the context of efficiently maintaining a high purity of hydrogen in hydroprocessing recycle gases, while minimizing the purge of hydrogen.

In hydroprocessing for producing hydrocarbons, hydrogen is a reagent which is consumed in significant amounts. It is important for many processes that hydrogen is present in excess. To ensure a cost-effective process hydrogen gas is therefore typically recycled in such processes. A further aspect is the fact that the hydrogen partial pressure is a key factor defining the rates and equilibrium of the hydroprocessing reactions.

However, in many hydroprocessing processes, other gases, such as methane, propane, water and CO₂ are produced, and their presence in the gas phase will reduce the hydrogen partial pressure for a constant total pressure.

Specifically, in hydroprocessing of oxygenates, such as renewable feedstocks, CO₂ is produced, and focus has been of the removal of CO₂ by an amine wash, which also removes H₂S from the recycle gas, which causes a need for addition of H₂S to maintain activation of sulfided base metal catalysts.

With the present disclosure we have however identified that a more efficient way to improve recycle gas purity is to remove methane. The reason is that the CO₂ produced is in equilibrium with CO. In the presence of high amounts of hydrogen, CO and H₂ may react to form methane.

The boiling points of methane and hydrogen are −162° C. and −253° C., and therefore separation of methane from hydrogen by cryogenic methods is possible, and although costly this has been a preferred method in other fields.

We have now identified a cost-effective process for providing a significant increase in purity of hydrogen rich recycle gas, by continually withdrawing just a moderate amount of methane from the gas phase of a hydroprocessed product stream. This is done by directing this gas phase to contact a hydrocarbon stream, in which methane is soluble.

In the following hydrogen shall be used to signify gaseous molecular dihydrogen, unless indicated otherwise.

In the following a hydrocarbonaceous feedstock shall be used to signify a feedstock rich in molecules comprising hydrogen and carbon, but possibly also other elements (heteroatoms), such as oxygen, sulfur and nitrogen.

In the following a hydroprocessing process shall be used to signify any process reacting a hydrocarbonaceous feedstock or intermediate product in the presence of a catalytically active material and hydrogen.

In the following a hydrotreatment process shall be used to signify any process treating a hydrocarbonaceous feedstock or intermediate product in the presence of a catalytically active material and hydrogen, in which the objective and dominant reaction is conversion by addition of hydrogen in the existing hydrocarbon structure, typically while either removing heteroatoms such as sulfur, oxygen or nitrogen or while saturating olefinic bonds. Hydrotreatment may have the effect of rearranging the structure of some hydrocarbons, but it is not the primary objective or effect of hydrotreatment.

In the following a Cn hydrocarbon (where n is an integer) shall be used to signify any hydrocarbon and/or oxygenate molecule comprising n carbon atoms, and correspondingly Cn+, shall be used to signify n or more carbon atoms. As an example, C3 represents propane and other C₃HₓO_{y} molecules, and C3+ represents propane, butane and all other hydrocarbons and oxygenates with at least 3 carbon atoms.

In the following means of separation may be referred to as “high pressure means of separation”, such as “high pressure separator” or “high pressure stripper”. This shall, in accordance with the practice in the art, be understood as equipment operating at pressures closer to process pressure than to ambient pressure. Similar “low pressure” in this context shall be understood as closer to ambient pressure than process pressure.

A broad aspect of the present disclosure relates to a process for conversion of a feedstock rich in oxygenates to a liquid product stream of hydrocarbons comprising the steps of directing said feedstock in combination with a recycle gas stream to a hydroprocessing step, to provide a two-phase hydroprocessed process stream comprising at least hydrogen, methane and hydrocarbons, combining a methane lean stream of hydrocarbons being liquid at ambient temperature and pressure, with a methane donor stream being either (i) said two-phase hydroprocessed process stream or (ii) a gaseous hydroprocessed stream derived from the two-phase hydroprocessed process stream by phase separation, to provide a multiple-phase combined stream, separating said multiple-phase combined stream in at least a hydrogen rich gas stream comprising a majority of the hydrogen comprised in said hydroprocessed process stream and a rich liquid hydrocarbon stream comprising absorbed methane, in a desorption step desorbing an amount of methane from said rich liquid hydrocarbon stream such as by a flashing process or by a stripping process, in order to transfer an amount of methane to the gas phase, in order to provide a methane rich gaseous stream, and in order to provide a liquid product stream of hydrocarbons. The transfer of methane may be to a methane rich gas phase which has a higher concentration of methane than the gas phase of the methane donor stream or it may be to another stream. The liquid hydrocarbon stream will have an increased capacity for absorbing methane, compared to the rich liquid hydrocarbon stream. This has the associated benefit of such a process being efficient in reducing the amount of methane in the recycle gas stream, which enables an increased partial pressure of hydrogen by facilitating release of methane in a separate stream. The increased partial pressure of hydrogen is beneficial for the hydroprocessing reactions, which may increase selectivity and reaction rate with an increased partial pressure of hydrogen. The capacity of the liquid stream of hydrocarbons for dissolving methane will be defined by the nature of the stream, the amount of methane and other gases contained therein and the physical conditions such as pressure and temperature. The process involves provision of a capacity for absorbing methane in a methane lean stream of hydrocarbons by contacting this stream with a hydroprocessed process stream comprising methane and separating one or more intermediate streams in a gas phase and a liquid phase, including a gas stream rich in hydrogen and a gas stream rich in methane and a liquid hydrocarbon stream.

In a further embodiment said methane lean stream of hydrocarbons is combined with the two-phase hydroprocessed process stream to provide a multiple-phase combined stream, prior to cooling and phase separation of the multiple-phase combined stream to provide said hydrogen rich gas stream and said rich liquid hydrocarbon stream. This has the associated benefit of providing some of said cooling by quench with the methane lean stream of hydrocarbons. If the methane lean stream of hydrocarbons is a stream rich in naphtha, an amount or all of this stream may be sufficiently heated to be in the gas phase before further cooling, and the evaporation will provide for efficient transfer of energy. If the methane lean stream of hydrocarbons is a stream which has been stripped of gases in a stripper or a fractionation column, the capacity for absorption of methane will be higher than for streams not having undergone this.

In a further embodiment the two-phase hydroprocessed process stream is cooled, and phase separated by a flashing step, to provide a gas stream and a liquid stream and wherein the methane lean stream of hydrocarbons is combined in a combining step with the gas stream to provide said multiple-phase combined stream. This has the associated benefit of such a process being simple to control and implement.

In a further embodiment, the flashing step as well as the combining step are made in an integrated absorption zone and flashing zone, such that the methane lean stream of hydrocarbons is combined with the two-phase hydroprocessed hydrocarbon stream to provide said stream rich liquid stream of hydrocarbons comprising the methane. This has the associated benefit of simplifying the process by enabling use of a single unit for flash separation and absorption, but also allows for integration with other parts of the process, e.g. by enabling separation of absorbed methane in a stripper included for other separation purposes.

In a further embodiment the flashing step as well as the combining step are carried out in separate devices for flash separation and absorption. This has the associated benefit of enabling re-use of an existing train of separators in a revamp of an existing process plant, where the process is added, and enables the methane enriched liquid stream may be kept separate from the liquid hydroprocessed hydrocarbon stream.

In a further embodiment separating said two-phase hydroprocessed process stream, is carried out, after optional cooling, by directing the two-phase hydroprocessed process stream to a high pressure stripper receiving a stripping medium, and providing a stripped liquid stream and a stripper overhead stream. This has the associated benefit of the intermediate streams being maintained at high pressure and thus minimizing energy and equipment compared to a configuration with low pressure separation Furthermore the stripper condensate will have a low molecular weight compared to other streams, and thus a higher capacity per volume of alternative lean liquid hydrocarbons.

In a further embodiment said stripper overhead stream constitutes the gaseous hydroprocessed stream, which is combined with a methane lean liquid stream of hydrocarbons prior to being directed to a first separator, providing at least said methane enriched liquid stream of hydrocarbons and said hydrogen rich gaseous stream, and in which said methane rich liquid stream is directed to a further separator providing said desorption step, to provide a methane reduced liquid stream and the methane rich gaseous stream.

In a further embodiment the pressure of the multiple phase combined stream is at least 3000 kPa or at least 50% of the pressure of the hydroprocessing reactor. This has the associated benefit of being compatible with the high pressure hydroprocessing process, and furthermore that the solubility of methane is higher at high pressure.

In a further embodiment the temperature of the multiple phase combined stream is from 20° C. to 275° C., such as from 20° C. to 90° C. or from 200° C. to 275° C. This has the associated benefit of solubility of methane being higher at temperatures below the effluent temperature of the hydroprocessed multiphase stream from the reactor, and specifically the benefit of operating at a low temperature corresponding to a cold high pressure separator where water is condensed, or alternatively at a higher temperature corresponding to a hot high pressure separator, from which the liquid fraction is commonly used for recycling, and from which the liquid stream of hydrocarbons may be withdrawn in a simple fashion.

In a further embodiment the desorption step comprises decreasing the pressure to less than 2000 kPa. This has the associated benefit of releasing a very high amount of the absorbed methane, such that the liquid stream of hydrocarbons regains a high capacity for absorption of methane.

In a further embodiment the desorption step comprises stripping the methane enriched liquid stream of hydrocarbons with a stripping medium, such as hydrogen or steam. This has the associated benefit of actively driving out a very high amount of the absorbed methane, in a process step typically included to ensure the purity of the product, without adding process steps.

In a further embodiment the desorption step involves a decrease of pressure by 80% or more of the pressure before desorption.

In a further embodiment the liquid product stream of hydrocarbons comprises at least an amount of the methane reduced liquid stream or a product of further hydroprocessing of the methane reduced liquid stream. This has the associated benefit of reducing the consumption of the liquid stream of hydrocarbons by recycle instead of adding a fresh liquid stream of hydrocarbons.

In a further embodiment the liquid stream of hydrocarbons comprises at least an amount of the liquid hydroprocessed stream or a product of further hydroprocessing of the liquid hydroprocessed stream. This has the associated benefit of operating the process without unnecessary addition of process streams.

A further aspect of the invention relates to a process plant comprising a hydroprocessing section having a liquid phase inlet, a gas phase inlet and an outlet, a first means of separation having an inlet, a liquid phase outlet and a gas phase outlet, a means of absorption, having a liquid inlet and a gas phase inlet, a liquid phase outlet and a gas phase outlet, optionally in an integrated device in the same pressure vessel as said first means of separation such that by the gas phase outlet of the first means of separation, the gas phase inlet of the means of absorption and the liquid phase outlet of the means of absorption are internal to the integrated device, a second means of separation having an inlet, a liquid phase outlet and a gas phase outlet, wherein the liquid phase inlet of the hydroprocessing section is configured to receive an oxygenate feedstock, the gas phase inlet of the hydroprocessing section is configured to receive a gas rich in hydrogen, and the outlet of the hydroprocessing section is in fluid communication with the inlet of the first means of separation, the gas phase outlet of the first means of separation is in fluid communication with the gas phase inlet of the means of absorption, a liquid hydrocarbon stream is directed to said liquid phase inlet of the means of absorption and the gas phase outlet of the means of absorption is in fluid communication with said gas phase inlet of the hydroprocessing section, optionally via a means of purification, the liquid phase outlet of the means of absorption is in fluid communication with the inlet of said second means of separation. This has the associated benefit of such a process plant being efficient in reducing the amount of methane in the recycle gas stream, which enables an increased partial pressure of hydrogen. The increased partial pressure of hydrogen is beneficial for the hydroprocessing reactions, which may increase selectivity and reaction rate with an increased partial pressure of hydrogen.

In a further embodiment the process plant further comprises a means of pressurization having an inlet and an outlet, wherein the liquid phase outlet of said second means of separation is in fluid communication with the inlet of said means of pressurization, and the outlet of said means of pressurization is in fluid communication with the inlet of said means of absorption. This has the associated benefit of allowing a recycle operation of the absorber section, such that the consumption of liquid hydrocarbon for absorption is minimized.

A yet further aspect of the present disclosure relates to an integrated means of separation and absorption comprising a multiple phase stream inlet, a liquid phase inlet, a liquid phase outlet and a gas phase outlet,
said integrated means of separation and absorption comprising a separation zone and an absorption zone in a single pressure vessel,
wherein said separation zone is positioned below said absorption zone and configured to allow fluid communication between the separation zone and the absorption zone,
and wherein said absorption zone, has a liquid inlet and a gas phase outlet, and optionally comprises means for enhancing the contact between gas and liquid.

This has the associated benefit of such an integrated means of separation being cost-effective and that it establishes a possibility for integration with a further stripper section in the process plant.

The conversion of oxygenates to hydrocarbons is a common process for production of renewable transportation fuels. The oxygenate feedstock typically comprises one or more oxygenates taken from the group consisting of triglycerides, fatty acids, resin acids, ketones, aldehydes or alcohols where said oxygenates may originate from one or more of a biological source and a thermal and/or catalytic degradation process, including a gasification process or a pyrolysis process, such that a wide range of feedstocks, especially of renewable origin may be converted into hydrocarbons. This includes feedstocks originating from plants, algae, animals, fish, vegetable oil refining, other biological sources, domestic waste, industrial biological waste like tall oil or black liquor as well as non-biological waste comprising suitable compositions, such as plastic fractions, typically after a thermal and/or catalytic degradation process. In addition, oxygenates may be provided synthetically, typically from a fossil or renewable synthesis gas via Fischer-Tropsch synthesis.

The production of hydrocarbon products typically requires one or more hydroprocessing steps which most commonly are; hydrotreatment for removing heteroatoms and saturating double bonds, hydroisomerization for adjusting hydrocarbon molecule structure and hydrocracking for reducing hydrocarbon molecular weight.

During hydroprocessing, oxygenates are combined with an excess of hydrogen and react in hydrodeoxygenation processes as well as in decarboxylation and decarbonylation processes, where water, carbon dioxide and carbon monoxide are released from the oxygenates, and an amount of carbon dioxide is converted to carbon monoxide by the water/gas shift process. Typically, around 10 wt % of the oxygenate feedstock is oxygen, and thus a significant amount of the product stream will be water, carbon dioxide and carbon monoxide. In addition, an amount of light hydrocarbons (especially methane and propane) may also be present in the product stream, depending on the nature of the feedstock and the side reactions occurring. Hydrotreatment may also involve extraction of other hetero-atoms and/or saturation of double bonds.

Typically, hydrotreatment, such as deoxygenation and hydrogenation, involves directing the feedstock stream comprising oxygenates to contact a catalytically active material comprising sulfided molybdenum, or possibly tungsten, and/or nickel, supported on a carrier comprising one or more refractory oxides, typically alumina, but possibly silica or titania. The support is typically amorphous. The catalytically active material may comprise further components, such as boron or phosphorous. The conditions are typically a temperature in the interval 250-400° C., a pressure in the interval 30-150 Bar, and a liquid hourly space velocity (LHSV) in the interval 0.1-2. The deoxygenation will involve a combination of hydrodeoxygenation producing water and decarboxylation producing CO₂ with a selectivity which, depending on conditions and the nature of the catalytically active material may vary from above 90% hydrodeoxygenation to above 90% decarboxylation. Deoxygenation is typically exothermal, and with the presence of a high amount of oxygen, the process may involve intermediate cooling e.g. by quenching with cold hydrogen, feed or product. The feedstock may preferably contain an amount of sulfur to maintain sulfidation of the metals, in order to maintain their activity. If the feedstock stream comprising oxygenates comprises less than 10, 50 or 100 ppm_{w} sulfur, a sulfide donor, such as dimethyldisulfide (DMDS) has typically been added to the feed.

Under the conditions in the HDO reactor, the equilibrium of the water gas shift process causes a conversion of CO₂ and H₂ to CO and H₂O. In the presence of the base metal catalyst an amount of methanation will take place, converting CO and H₂ to CH₄ and H₂O.

Especially when treating fatty acids, triglycerides and Fischer-Tropsch products, the deoxygenation process provides a product rich in linear alkanes, having poor cold flow properties, and therefore the deoxygenation process may be combined with a hydroisomerization process, with the aim of improving the cold flow properties of products, and/or a hydrocracking process, with the aim of adjusting the boiling point of products.

Typically, rearrangement of molecular structure by hydroisomerization involves directing an intermediate deoxygenated product stream feedstock to contact a material catalytically active in hydroisomerization comprising an active metal (either elemental noble metals such as platinum and/or palladium or sulfided base metals such as nickel, cobalt, tungsten and/or molybdenum), an acidic support (typically a molecular sieve showing high shape selectivity, and having a topology such as MOR, FER, MRE, MWW, AEL, TON and MTT) and a refractory support (such as alumina, silica or titania, or combinations thereof). The catalytically active material may comprise further components, such as boron or phosphorous. The conditions are typically a temperature in the interval 250-350° C., a pressure in the interval 20-100 Bar, and a liquid hourly space velocity (LHSV) in the interval 0.5-8. Isomerization is substantially thermally neutral and hydrogen is typically not consumed in the isomerization reaction, although a minor amount of hydrocracking side reactions consuming hydrogen may occur. The active metal on the material catalytically active in isomerization may either be a sulfided base metal or a reduced noble metal. If it is a noble metal, the deoxygenated feedstock is typically purified by gas/liquid separation section often involving a stripping process, which typically will use hydrogen as stripping medium, but other stripping media such as steam may also be used, to reduce the content of sulfur to below 1-10 ppm_{w}. If the active metal is a base metal, the feed to hydroisomerization may preferably contain an amount of sulfur to maintain sulfidation of the metals, in order to maintain their activity.

Hydrocracking will adjust the cold flow properties as well as the boiling point characteristics of a hydrocarbon mixture, by cracking large molecules into smaller. Typically, hydrocracking involves directing an intermediate feedstock to contact a catalytically active material comprising an active metal (either elemental noble metals such as platinum and/or palladium or sulfided base metals such as nickel, cobalt, tungsten and/or molybdenum), an acidic support (typically a molecular sieve showing high cracking activity, and having a topology such as MFI, BEA and FAU) and a refractory support (such as alumina, silica or titania, or combinations thereof). The catalytically active material may comprise further components, such as boron or phosphorous. While this overall composition is similar to the material catalytically active in isomerization the difference is typically the nature of the acidic support, which may be of a different structure (even amorphous silica-alumina) or have a different—typically higher—acidity e.g. due to silica:alumina ratio. The conditions are typically a temperature in the interval 250-400° C., a pressure in the interval 30-150 Bar, and a liquid hourly space velocity (LHSV) in the interval 0.5-8, optionally together with intermediate cooling by quenching with cold hydrogen, feed or product.

A hydroprocessed stream comprising hydrocarbons, excess hydrogen and inorganic molecules comprising heteroatoms must be separated in hydrocarbons and molecules -typically gases—comprising heteroatoms. To do this, the hydroprocessed stream is directed to a separation section, which for process scenarios relating to the treatment of fatty acids and triglycerides typically either will be between a base metal based hydrodeoxygenation reactor and a noble metal based hydroisomerization reactor, or if the material catalytically active in hydroisomerization comprises base metals, downstream the hydroisomerization reactor. The process may also comprise one or more other conversion steps, such as hydrocracking or hydrodearomatization, and depending on the sequence of these steps and the catalytically active metals used, the skilled person will be aware of the possible positions for introducing a separation section with the purpose of withdrawing a recycle gas stream.

As the development of heat and the consumption of hydrogen is high in processes treating feedstocks rich in oxygenates, the gas to oil ratio in the hydroprocessing reactors is also very high compared to other hydroprocessing processes, such as from 1000 to 2000 Nm³/m³.

For a hydrocarbonaceous feedstock rich in oxygenates, such as Fischer-Tropsch products and hydrocarbonaceous feedstock of biological origin, the hydroprocessed stream will mainly contain long linear hydrocarbons, methane, propane, water and to some extent carbon oxides, and in addition nitrogen in the hydrocarbonaceous feedstock will result in ammonia in the hydroprocessed stream. Added sulfur as well as any sulfur in the hydrocarbonaceous feedstock will be present as hydrogen sulfide in the hydroprocessed stream, and finally an excess amount of hydrogen will pass unreacted to the hydroprocessed stream.

The presence of CH₄ in the gas phase, in a reactor system with a given pressure, has the effect of replacing an amount of H₂ and thus reducing the partial pressure of H₂, which effects the reaction kinetics and equilibrium of the reaction. To ensure maximum and intended reaction conditions it is desirable to remove an amount of the CH₄.

Commonly the separation of the hydroprocessed stream will involve multiple steps. If the temperature is below the water dew point, the hydroprocessed stream will typically be a three-phase stream, and the first separation step will be a high pressure cold separator, separating a first vapor stream from a (often two phase) liquid. The two liquid phases are separately directed to a low pressure cold separator, which typically also is a three way separator, providing a hydrogen rich gas stream (typically originating from the hydrogen dissolved in the oil), a non-polar product stream and a polar (aqueous) stream. The hydrocarbon product stream may be directed to a product stripper for separating off-gas (mainly light hydrocarbons with 1 to 5 carbons) from a stabilized product, by using a stripping medium which typically is either steam or hydrogen. The polar stream will typically be separated in a sour water stripper, where the conditions are defined such that the so-called sour gases, ammonia, hydrogen sulfide and carbon oxides are separated from the water by a stripping process employing a stripping medium, typically steam, or by reboiling. The off gas from this separation may be directed to purification in an amine absorber tower, a solid adsorbent or a caustic scrubber, for collecting hydrogen sulfide ammonia and carbon oxides, but it may also with little or no purification be directed as process recycle gas together with a hydrogen rich gas, with an amount withdrawn for purge.

Alternatively, the separation of the hydroprocessed stream may involve directing the hydroprocessed stream to a high pressure stripper, in which a stripping medium (typically a stream rich in hydrogen) supports efficiently separating vapor from liquid. The high pressure stripper will have an outlet for a liquid stream at the bottom and an overhead stream at the top. The overhead stream will contain some condensable product and will be directed to a separator train comprising a high pressure separator and a possibly a low pressure separator, such that a polar (aqueous) stream, a non-polar liquid hydrocarbon stream for reflux in the stripper and gases are separated. The further treatment of the streams will be similar to what is described above.

A drawback of operation under recycle is that impurities are concentrated with the recycling. To avoid this, an amount of the stream may be purged from the system, but this has the cost of losing an amount of the material recycled. However, just as the effect of recycling amplifies the concentration of impurities it may also amplify the effect of purification, such that removal of even a minor amount of e.g. methane may have a large effect on the composition of the recycle stream.

One way of removing an amount of gaseous hydrocarbons is to absorb them in liquid hydrocarbon. Methane is only moderately soluble in liquid hydrocarbons, so traditionally liquid hydrocarbon absorbers are mainly used for capture C3 and C4 from gas streams and not methane from a hydrogen rich recycle gas. Nevertheless, we have identified (in a process operating at 57 Bar) that by employing a liquid hydrocarbon absorber which only captures 7.4% of the methane in the reactor effluent, the partial pressure of methane is reduced 36%, from 14.8 Bar to 9.5 Bar, which may correspond to an increased partial pressure of 5.8 Bar for hydrogen, with the associated increase in process benefits. In addition the liquid hydrocarbon may capture about 50% of the propane present in the effluent gas, corresponding to 2.1 Bar increase in hydrogen pressure.

US 2020/353409 discloses a process for scrubbing with a liquid butane and pentane solvent at −31.4° C. for extracting H₂S and light hydrocarbons from a hydrogen rich stream.

US 2021/060516 discloses a process for stabilization of a liquid product, by stripping of gases and absorbing dissolved LPG product in recycled naphtha product.

The capturing of methane in a lean oil may be implemented in different ways. If an existing plant is revamped, e.g. from fossil hydrocracking to renewables hydroprocessing, the most cost-effective approach may be to re-use an existing separator train and establish an added liquid hydrocarbon absorber circuit in which a liquid hydrocarbon absorber, configured for providing a high contact area between liquid and gas, receives a liquid stream of hydrocarbon and a gaseous hydroprocessed stream. The liquid stream will leave the liquid hydrocarbon absorber as a methane enriched stream and be directed to a flash drum at low pressure which works as a desorption step, where absorbed gas is separated as a rich gaseous stream from the depleted liquid hydrocarbon stream. The liquid hydrocarbon may then be pressurized and recycled to the liquid hydrocarbon absorber and the rich gaseous stream may be directed as gas product, directed for hydrogen production or used in the process in other ways. As an amount of liquid hydrocarbon will be transferred to the rich gas stream, a minor amount of liquid hydrocarbon must be added to the process. This could be product transferred from the product stripper bottom, or another appropriate liquid hydrocarbon.

If a new plant is built, it may be more cost-effective to provide an integrated unit for separation of the hydroprocessed product and absorption. Especially if the value of efficient separation is high it may be beneficial to provide an efficient absorption/separation layout, possibly with hardware supporting the absorption, such as trays, filling elements or even a separate absorption tower. In this case a low pressure cold separator and a stripper will provide the separation of methane and liquid hydrocarbon and the stripped liquid may be pressurized and used as liquid hydrocarbon for absorption.

If the gas/liquid separation is carried out in a high pressure stripper, an embodiment of the present disclosure may involve directing an amount of the condensed non-polar overhead stream to be combined with the stripper overhead, such that the capacity for methane and propane absorption is increased. The high pressure separator would then release hydrogen for recycle and the low pressure separator would release a majority of the captured methane and propane.

The unit in which lean oil and methane rich gas are brought into contact may beneficially be configured to comprise means for enhancing the gas/liquid contact. This may be separation unit trays or inert filling elements.

The lean oil to be used for capturing methane may be chosen from a wide range of available oils, depending on plant layout and size. As the solubility per mole of liquid is similar, low molecular weight lean oil will typically have a higher absorption capacity per volume. Furthermore, a lean oil stripped of gases will also have a higher absorption capacity. This means that a lower volume of lean oil is required if stabilized light naphtha (C5 to C7) is used as lean oil, compared to a full liquid product after flash separation (dominated by C14 to C18, but also comprising a minor amount of lighter hydrocarbons). This extra capacity must of course be balanced against the benefits and costs of the process layouts required for providing the lean oil, and the possible use of the lean oil and the captured gases.

If the production of renewable methane and/or propane is of sufficient value, e.g. for sale as liquified gas, a high capture of these gases may be of extra value. This may typically be the case for larger plants.

In other cases, especially revamps of existing plants, the source of lean oil may be dictated by the physical layout and availability of equipment, but also process parameters may be of influence. One example of this may be that a low operating pressure may dictate a need for a more complete removal of methane, to ensure the highest possible hydrogen partial pressure.

The operational parameters for absorption will define the amount of gases captured. As the hydrogen consumption is high, the gas to oil ratio is also high in typical processing of oxygenates. Therefore the operation of the absorber may also involve very high volumes of liquid hydrocarbon for absorption, such as a ratio between liquid feedstock and methane lean hydrocarbon above 1, 2, 4 or even 7; that is a flow of lean hydrocarbon up to four times the flow of liquid feedstock and product, and a gas to oil ratio in the absorber of 200 Nm³/m³ to 2000 Nm³/m³. If the operation involves revamping existing equipment the present disclosure will however also be of benefit at lower ratios than those listed above.

The pressure of the lean hydrocarbon is also of consideration. While the solubility of methane in alkanes increase as a function of pressure, this effect is higher for hydrogen. Therefore, the selectivity for methane is decreased with increasing pressure, and the effect on hydrogen purification is thus higher for moderate pressures such as 3000 kPa to 8000 kPa than for pressures above this level.

### BRIEF DESCRIPTION OF FIGURES

FIG. 1 shows a process layout according to the present disclosure suited for revamping an existing plant.

FIG. 2 shows a process layout according to the present disclosure suited for building a new plant.

FIG. 3 shows a process layout according to the prior art.

FIG. 4 shows a process layout according to the present disclosure employing a high pressure stripper.

FIG. 5 shows a process layout according to the present disclosure employing a high pressure stripper with an integrated absorber/separator.

FIG. 6 shows a process layout according to the prior art employing a high pressure stripper.

FIG. 7 shows a process layout according to the prior art employing a high pressure strip-per.

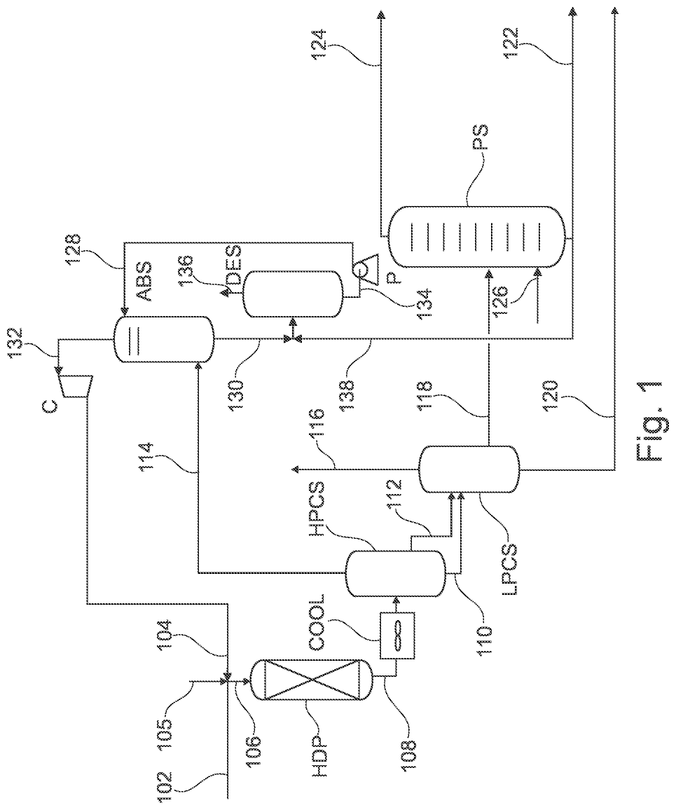

FIG. 1 shows a process layout according to the present disclosure suited for revamping an existing plant, with an existing layout comprising a high pressure cold separator and a low pressure cold separator, in which a hydrocarbonaceous feedstock stream 102, such as a mixture rich in oxygenates, together with a recycle gas stream 104, and an amount of make-up hydrogen 105, is directed as a total feed stream to a hydroprocessing reactor HDP, comprising a material catalytically active in hydroprocessing, to provide a multiple-phase hydroprocessed stream 108. In the case of a feedstock rich in oxygenates, the catalytically active material is active in hydrodeoxygenation, and for other feedstocks, the catalytically active material may be active in other hydrotreatment processes, hydroisomerization or hydrocracking. The multiple-phase hydroprocessed stream 108 is (after cooling) directed to a high pressure cold separator HPCS, where the multiple-phase hydroprocessed stream 108 is separated in a polar liquid stream 110 (which may not be present if the hydrocarbonaceous feedstock is not rich in oxygenates), a non-polar liquid stream 112 and a gaseous hydroprocessed stream 114, which will comprise light gases such as unreacted hydrogen, methane, propane, and hydrogen sulfide. Both liquid streams 110, 112, are directed to a downstream low pressure cold separator LPCS. In the low pressure cold separator LPCS the input is separated in three phases; a hydrogen rich gas stream 116, mainly comprising hydrogen and methane dissolved in the non-polar liquid stream 112, a non-polar product stream 118 and a polar sour water stream 120 which is directed to a sour water system.

The non-polar product stream 118 is directed to a product stripper PS, in which a product stream 122 is separated from a stripper vapor 124 by use of a stripping medium such as steam 126. The stripper will typically operate with reflux and a polar stream may also be condensed and directed to a sour water system

The gaseous hydroprocessed stream 114 is directed to an absorber ABS, also receiving a lean liquid stream of hydrocarbons 128, which is effectively contacted with the gaseous hydroprocessed stream, to maximize capturing of methane in the liquid stream of hydrocarbons, to provide a methane enriched liquid stream of hydrocarbons 130 and a methane reduced gaseous stream 132, which may be pressurized in compressor C, and directed as recycle gas 104. In a cold low pressure separation for desorption DES, the mixture is flashed, to separate a methane reduced liquid stream 134 and a methane rich gaseous stream 136. The methane reduced liquid stream 134 is pressurized in pump P and recycled as the lean liquid stream of hydrocarbons 128. As an amount of liquid hydrocarbons may be present in the methane rich gaseous stream 136, a make-up stream of liquid hydrocarbons 138 may be provided, e.g. from the product outlet of the product stripper PS.

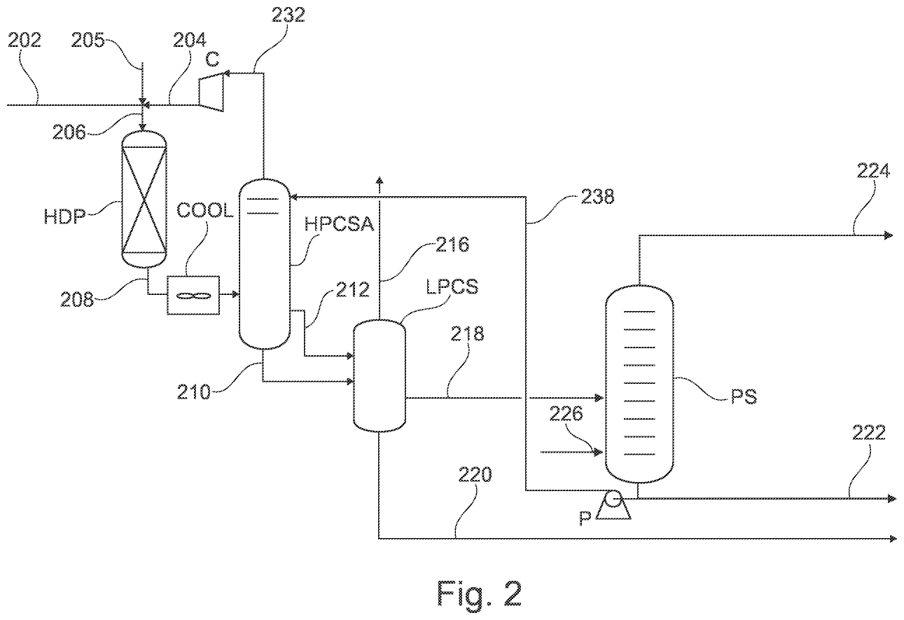

FIG. 2 shows a process layout according to the present disclosure suited for a plant in which there is no tie of existing equipment. Again, a hydrocarbonaceous feedstock stream 202, such as a mixture rich in oxygenates, together with a recycle gas stream 204, and an amount of make-up hydrogen 205, is directed as a total feed stream to a hydroprocessing reactor HDP, comprising a material catalytically active in hydroprocessing, to provide a multiple-phase hydroprocessed stream 208. In the case of a feedstock rich in oxygenates, the catalytically active material is active in hydrodeoxygenation, and for other feedstocks, the catalytically active material may be active in other hydrotreatment processes, hydroisomerization or hydrocracking. The multiple-phase hydroprocessed stream 208 is (after cooling) directed to an integrated high pressure cold separator-absorber HPCSA. In the integrated high pressure cold separator-absorber HPCSA, the multiple-phase hydroprocessed stream 208 is separated in a polar liquid stream 210 (which may not be present if the hydrocarbonaceous feedstock is not rich in oxygenates), a non-polar liquid stream 212 and a gaseous phase, which will comprise light gases such as unreacted hydrogen, methane, propane, and hydrogen sulfide. In the top part of the integrated high pressure cold separator-absorber HPCSA, a lean liquid stream of hydrocarbons 238 is received and contacts the gaseous phase of the hydroprocessed stream, and absorbs methane and other soluble gases, and releases a methane reduced gaseous stream 232, which may be pressurized in compressor C, and directed as recycle gas 204. Both liquid streams 210, 212 are directed to a downstream low pressure cold separator LPCS. In the low pressure cold separator LPCS the input is separated in three phases; a hydrogen rich gas stream 216, mainly comprising hydrogen and methane dissolved in the non-polar liquid stream 212, a non-polar product stream 218 and a polar sour water stream 220 which is directed to a sour water system.

The non-polar product stream 218 is directed to a product stripper PS, in which a product stream 222 is separated from a stripper vapor 224 by use of a stripping medium such as hydrogen 226. The stripper will typically operate with reflux and a polar stream may also be condensed and directed to a sour water system. An amount of the product stream is pressurized in pump P and directed as the lean liquid stream of hydrocarbons 238 for the integrated high pressure cold separator-absorber HPCSA, but other streams could also be used for this purpose.

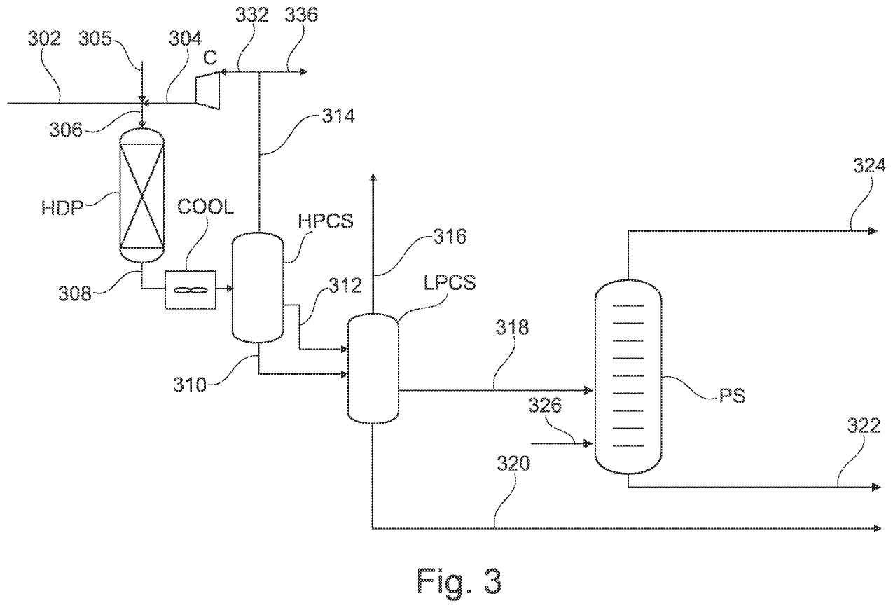

FIG. 3 shows a process layout according to the prior art, in which a hydrocarbonaceous feedstock stream 302, such as a mixture rich in oxygenates, together with a recycle gas stream 304, and an amount of make-up hydrogen 305, is directed as a total feed stream to a hydroprocessing reactor HDP, comprising a material catalytically active in hydroprocessing, to provide a hydroprocessed stream 308. In the case of a feedstock rich in oxygenates, the catalytically active material is active in hydrodeoxygenation, and for other feedstocks, the catalytically active material may be active in other hydrotreatment processes, hydroisomerization or hydrocracking. The hydroprocessed stream 308 is (after cooling) directed to a high pressure cold separator HPCS, where the hydroprocessed stream 308 is separated in a polar liquid stream 310 (which may not be present if the hydrocarbonaceous feedstock is not rich in oxygenates), a non-polar liquid stream 312 and a gaseous hydroprocessed stream 314, which will comprise unreacted hydrogen, methane, propane, and hydrogen sulfide. To avoid a build-up of undesired components, a purge stream 336 may be taken out, and the remaining stream of recycle gas 332, may be pressurized in compressor C, and directed as recycle gas 304. Both liquid streams 310, 312 are directed to a downstream low pressure cold separator LPCS. In the low pressure cold separator LPCS the input is separated in three phases; a hydrogen rich gas stream 316, mainly comprising hydrogen and methane dissolved in the non-polar liquid stream 312, a non-polar product stream 318 and a polar sour water stream 320 which is directed to a sour water system.

The non-polar product stream 318 is directed to a product stripper PS, in which a product stream 322 is separated from a stripper vapor 324 by use of a stripping medium such as hydrogen 326. The stripper will typically operate with reflux and a polar stream may also be condensed and directed to a sour water system

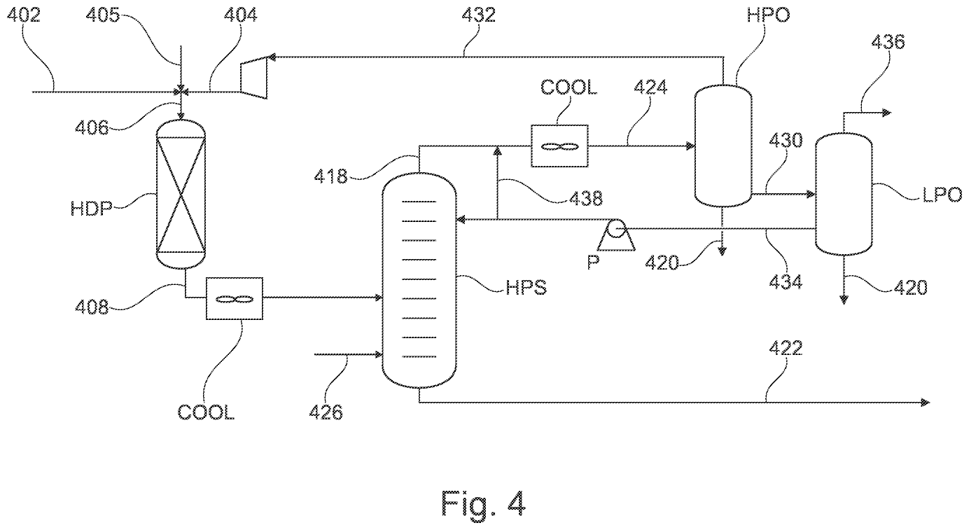

FIG. 4 shows a process layout according to the present disclosure in which separation is carried out in a high pressure stripper HPS. A hydrocarbonaceous feedstock stream 402, such as a mixture rich in oxygenates, is together with a recycle gas stream 404, and an amount of make-up hydrogen 405, is directed as a total feed stream to a hydroprocessing reactor HDP, comprising a material catalytically active in hydroprocessing, to provide a hydroprocessed stream 408. In the case of a feedstock rich in oxygenates, the catalytically active material is active in hydrodeoxygenation, and for other feedstocks, the catalytically active material may be active in other hydrotreatment processes, hydroisomerization or hydrocracking. The hydroprocessed stream 408 is (after cooling) directed to a high pressure stripper HPS, also receiving a stripping medium, typically hydrogen 426. The hydroprocessed stream 408 is separated in a stripped liquid stream 422 and a stripper vapor 418. The stripper overhead stream 418 is combined with a lean liquid stream of hydrocarbons 438 and cooled e.g. in an air cooler COOL. The cooled combined stripper overhead stream/lean oil mixture 424, is directed to a high pressure overhead separator HPO, in which the inlet is separated into sour water 420, a methane enriched liquid stream of hydrocarbons 430 and a methane reduced gaseous stream 432, which may be pressurized in compressor C, and directed as recycle gas 404. In a cold low pressure overhead separator LPO , the methane enriched liquid stream of hydrocarbons 430 is flashed, to separate a methane reduced liquid stream 434 and a methane rich gaseous stream 436, and typically also a sour water stream 420. The methane reduced liquid stream 434 is pressurized in pump P and recycled split in overhead condensate for the high pressure stripper HPS and as the lean liquid stream of hydrocarbons 438.

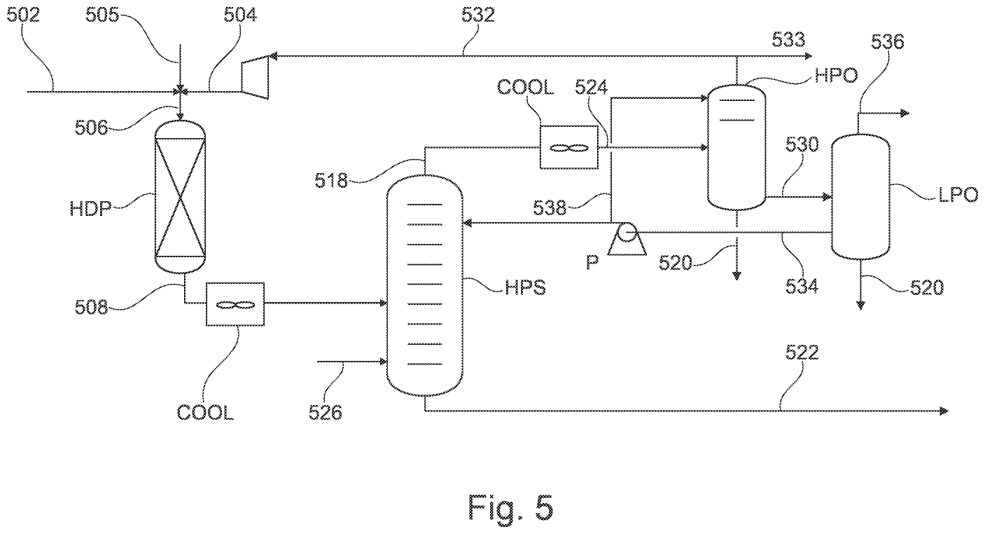

FIG. 5 shows an alternative process layout according to the present disclosure in which separation is carried out in a high pressure stripper HPS. A hydrocarbonaceous feedstock stream 502, such as a mixture rich in oxygenates, is together with a recycle gas stream 504, and an amount of make-up hydrogen 505, is directed as a total feed stream to a hydroprocessing reactor HDP, comprising a material catalytically active in hydroprocessing, to provide a hydroprocessed stream 508. In the case of a feedstock rich in oxygenates, the catalytically active material is active in hydrodeoxygenation, and for other feedstocks, the catalytically active material may be active in other hydrotreatment processes, hydroisomerization or hydrocracking. The hydroprocessed stream 508 is (after cooling) directed to a high pressure stripper HPS, also receiving a stripping medium, typically hydrogen 526. The hydroprocessed stream 508 is separated in a stripped liquid stream 522 and a stripper vapor 518. The stripper overhead stream 518 is cooled e.g. in an air cooler COOL. The cooled stripper overhead stream 524, is directed to a high pressure overhead absorber/separator HPOA, which comprises an inlet for a lean liquid stream of hydrocarbons 538 in addition to the inlet for the stripper overhead stream 524. The high pressure overhead absorber/separator HPOA is configured for providing contact between the lean liquid stream of hydrocarbons and the gas phase, and this contact may be enhanced by provision of trays or filling elements at the top of the high pressure overhead absorber/separator HPOA. The inlet is, similar to the embodiment illustrated in FIG. 4, separated into sour water 520, a methane enriched liquid stream of hydrocarbons 530 and a methane reduced gaseous stream 532, which may be pressurized in compressor C, and directed as recycle gas 504. An amount of this stream may be withdrawn as purge stream 533. In a cold low pressure overhead separator LPO , the methane enriched liquid stream of hydrocarbons 530 is flashed, to separate a methane reduced liquid stream 534 and a methane rich gaseous stream 536, and typically also a sour water stream 520. The methane reduced liquid stream 534 is pressurized in pump P and recycled split in overhead condensate for the high pressure stripper HPS and as the lean liquid stream of hydrocarbons 538, directed for the high pressure overhead absorber/separator HPOA.

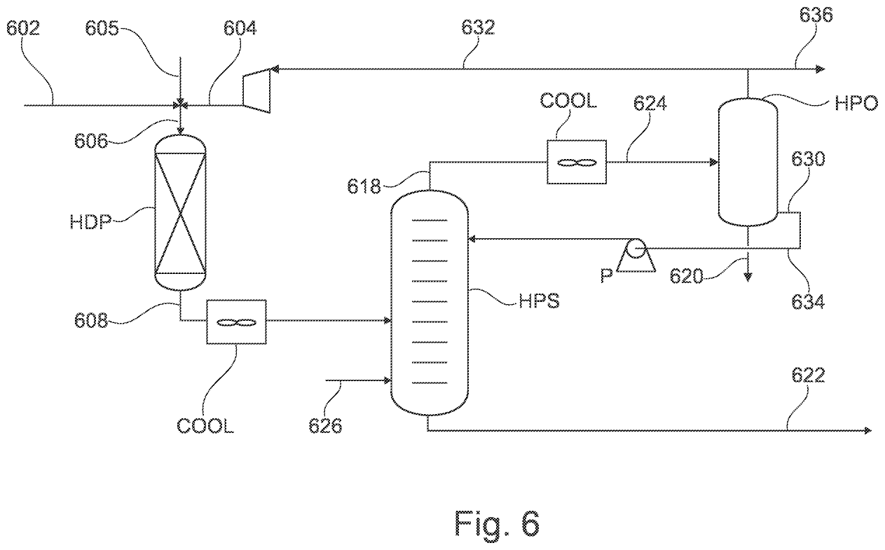

FIG. 6 shows an comparative alternative process layout according to the prior art in which separation is carried out in a high pressure stripper HPS. A hydrocarbonaceous feedstock stream 602, such as a mixture rich in oxygenates, is together with a recycle gas stream 604, and an amount of make-up hydrogen 605, is directed as a total feed stream to a hydroprocessing reactor HDP, comprising a material catalytically active in hydroprocessing, to provide a hydroprocessed stream 608. In the case of a feedstock rich in oxygenates, the catalytically active material is active in hydrodeoxygenation, and for other feedstocks, the catalytically active material may be active in other hydrotreatment processes, hydroisomerization or hydrocracking. The hydroprocessed stream 608 is (after cooling) directed to a high pressure stripper HPS, also receiving a stripping medium, typically hydrogen 626. The hydroprocessed stream 608 is separated in a stripped liquid stream 622 and a stripper overhead stream 618. The stripper overhead stream 618 is cooled e.g. in an air cooler COOL. The cooled stripper overhead stream 624, is directed to a high pressure overhead separator HPO, where the inlet stream is separated into sour water 620, a liquid stream of hydrocarbons 630 and a gaseous stream 632, which may be pressurized in compressor C, and directed as recycle gas 604. As the gaseous stream 632 contains methane, a purge stream may have to be taken out to avoid a build up of methane.

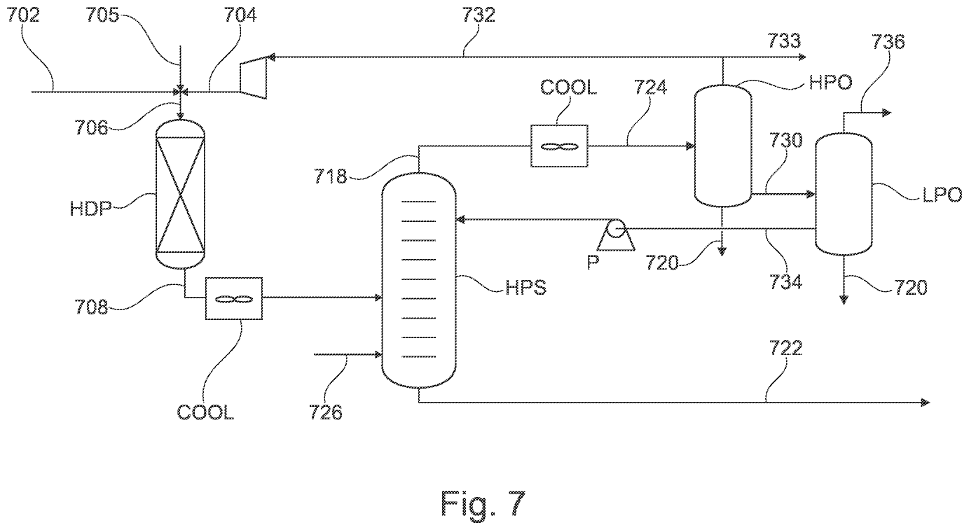

FIG. 7 shows a process layout according to the prior art in which separation is carried out in a high pressure stripper HPS. A hydrocarbonaceous feedstock stream 702, such as a mixture rich in oxygenates, is together with a recycle gas stream 704, and an amount of make-up hydrogen 705, is directed as a total feed stream to a hydroprocessing reactor HDP, comprising a material catalytically active in hydroprocessing, to provide a hydroprocessed stream 708. In the case of a feedstock rich in oxygenates, the catalytically active material is active in hydrodeoxygenation, and for other feedstocks, the catalytically active material may be active in other hydrotreatment processes, hydroisomerization or hydrocracking. The hydroprocessed stream 708 is (after cooling) directed to a high pressure stripper HPS, also receiving a stripping medium, typically hydrogen 726. The hydroprocessed stream 708 is separated in a stripped liquid stream 722 and a stripper vapor 718. The stripper overhead stream 718 is cooled e.g. in an air cooler COOL. The cooled stripper overhead stream 724, is directed to a high pressure overhead separator HPO, in which the inlet is separated into sour water 720, a liquid stream of hydrocarbons 730 and a gaseous stream 732, which may be pressurized in compressor C, and directed as recycle gas 704. An amount of this stream may be withdrawn as purge stream 733. In a cold low pressure overhead separator LPO , the liquid stream of hydrocarbons 730 is flashed, to separate a liquid stream 734 and a gaseous stream 736, and typically also a sour water stream 720. The methane reduced liquid stream 734 is pressurized in pump P and recycled as overhead condensate for the high pressure stripper HPS.

### EXAMPLES

The processes of the configuration shown in FIG. 2 and FIG. 3 were compared. In both processes a biological feedstock comprising rapeseed oil was hydrotreated, to complete hydrodeoxygenation, with the production of a liquid phase of the hydroprocessed stream.

In the process of the examples an amount of methane is produced after production of CO₂ by decarboxylation and subsequent conversion to CO and methanation to CH₄ in the hydrodeoxygenation reactor. In the process of the prior art, according to FIG. 3, a significant part of the methane produced is recycled with the hydrogen in the gas loop of the process. Contrary to this, in the process of the present disclosure, according to FIG. 2, an increased amount of methane may be absorbed in the lean hydrocarbon and withdrawn from the gas loop.

Table 1 shows the amount of light gases (in vol %) in the hydroprocessed stream 208, in the oil outlet 212 from the high pressure cold separator and absorber HPCSA, and in the methane reduced gaseous stream 232, which is directed as recycle gas, for the two processes. In this configuration, the ratio between the methane reduced gaseous stream 232 used as recycle gas and lean liquid stream of hydrocarbons 238 was 725 Nm³/m³. This corresponds to a total amount of combined liquid hydrocarbon withdrawn from the high pressure cold separator and absorber HPCSA of 156 m³/h.

Table 2 similarly shows the amount of light gases (in vol %) in the hydroprocessed stream 308, in the non-polar liquid stream 312 from the high pressure cold separator HPCS, and in the recycle gas 332, for the two processes. As no lean hydrocarbon is recycled, the total amount of liquid hydrocarbon withdrawn from the high pressure cold separator HPCS is only 90 m³/h, which constitutes a lower capacity for withdrawing methane from the recycle gas.

Of the methane leaving the hydroprocessing process in the hydroprocessed stream 308, in the process of FIG. 3 without absorber, 5.1% remains dissolved in the liquid phase. Contrary to this with an absorber in the process of FIG. 1, the amount of methane absorbed in the oil is increased to about 7.5%. Accordingly, the majority of methane is recycled to the recycle gas loop, but nevertheless, the small difference causes a significant difference in the stable concentration of methane, such that the inventive process decreases the concentration of methane in the recycle gas from 25.9% vol to 16.6% vol. In addition especially the amount of propane withdrawn from the recycle gas is increased and thus the amount of C1-C3 hydrocarbons in the recycle gas is reduced from 33.5% vol to 20.3% vol. This reduction corresponds to an increase in hydrogen concentration from 63.7% vol to 77.8% vol, which is an increase in partial pressure from 36 Bar to 44 Bar (assuming a pressure of 57.5 Bar), which would have required significant increased investment in process equipment, if it was sought to be implemented by increasing the overall pressure, which may not be possible when converting existing plants in a revamp.

The operation of the absorber may be varied by varying the amount of the liquid stream of hydrocarbons.

In Table 3 the effect of adjusting selected parameters in the process are shown. The two scenarios of Table 2 (no lean hydrocarbon used for absorption, as in FIG. 3) and Table 1 (lean hydrocarbon being diesel) are compared with a similar scenario with naphtha as lean hydrocarbon—all three at the same pressure. From this it is clear that an increased removal of methane, and related increase in hydrogen partial pressure may be obtained by using a light hydrocarbon, such as naphtha, if conveniently available. In the following two lines it is further seen that if the pressure of operation is 100 bar, the effect of absorption of methane in lean hydrocarbon is higher.

Table 4 shows an alternative approach to evaluating the benefit of the process. In this evaluation a process simulation was executed for FIG. 5 and FIG. 7 respectively on the basis of a total feed rate of 199 m³/h (streams 508 and 708), with the objective of a purity of at least 80 vol % in the hydrogen treat gas stream (the combination of streams 504 and 505 or 704 and 705). Comparing FIG. 5 and FIG. 4 shows that the presence of a lean hydrocarbon absorber results in a more pure recycle gas (72.6 vol % of 504 vs. 72.3 vol % of 704), a reduced amount of purge (533 and 536 combined vs. 733 and 736 combined) and thus 25,000 Nm³/h less make-up gas (505 vs 705).

TABLE 1

| Stream | | 208 | 212 | 232 |
|---|---|---|---|---|
| H₂O | % vol | 7.6 | 0.32 | 0.12 |
| H₂S | % vol | 0 | 0.04 | 0.02 |
| CO | % vol | 0.5 | 0.07 | 0.6 |
| CO₂ | % vol | 0.7 | 0.47 | 0.78 |
| H₂ | % vol | 60.7 | 4.03 | 77.76 |
| C1 | % vol | 13.8 | 4.24 | 16.62 |
| C2 | % vol | 0.8 | 0.81 | 0.75 |
| C3 | % vol | 4.5 | 9.16 | 2.92 |
| C4+ | % vol | 11.52 | 80.86 | 0.43 |

TABLE 2

| Stream | | 308 | 312 | 314 |
|---|---|---|---|---|
| H₂O | % vol | 7.6 | 0.37 | 0.12 |
| H₂S | % vol | 0.0 | 0.07 | 0.04 |
| CO | % vol | 0.5 | 0.08 | 0.65 |
| CO₂ | % vol | 0.9 | 0.67 | 1.08 |
| H₂ | % vol | 49.2 | 3.43 | 63.68 |
| C1 | % vol | 20.8 | 6.54 | 25.87 |
| C2 | % vol | 1.3 | 1.38 | 1.34 |
| C3 | % vol | 7.7 | 17.98 | 6.26 |
| C4+ | % vol | 12.0 | 69.49 | 0.98 |

TABLE 3

| Lean hydrocarbon | Pressure [bar] | H₂ [% vol] | C1 [% vol] |
|---|---|---|---|
| None | 57.5 | 63.68 | 25.87 |
| Diesel | 57.5 | 77.76 | 16.62 |
| Naphtha | 57.5 | 83.98 | 10.93 |
| None | 100 | 78.31 | 15.07 |
| Diesel | 100 | 86.81 | 9.45 |

TABLE 4

| Unit | Stream# | Value | Stream# | Value |
|---|---|---|---|---|
| 1000 Nm3/h | 505 | 931.0 | 705 | 956.0 |
| m3/h | 502 | 198.9 | 702 | 198.9 |
| m3/h | 508 | 220.2 | 708 | 218.5 |
| m3/h | 538 | 116.3 | | |
| 1000 Nm3/h | 533 | 87.5 | 733 | 127.3 |
| 1000 Nm3/h | 504 | 2475.9 | 704 | 2450.9 |
| vol % H₂ | | 72.6 | | 72.3 |
| 1000 Nm3/h | 536 | 24.0 | 736 | 16.7 |
| vol % H₂O | | 1.4 | | 0.9 |
| vol % H₂S | | 0.2 | | 0.1 |
| vol % CO | | 0.1 | | 0.1 |
| vol % CO₂ | | 0.6 | | 0.6 |
| vol % H₂ | | 23.2 | | 32.8 |
| vol % C1 | | 22.1 | | 24.7 |
| vol % C2 | | 7.7 | | 7.3 |
| vol % C3 | | 38.4 | | 29.4 |
| vol % C4+ | | 6.3 | | 4.1 |

1. A process for conversion of a feedstock rich in oxygenates to a liquid product stream of hydrocarbons comprising the steps of
a. directing said feedstock in combination with a recycle gas stream to a hydroprocessing step, to provide a two-phase hydroprocessed process stream comprising at least hydrogen, methane and hydrocarbons,
b. combining a methane lean stream of hydrocarbons being liquid at ambient temperature and pressure, with a methane donor stream being either (i) said two-phase hydroprocessed process stream or (ii) a gaseous hydroprocessed stream derived from the two-phase hydroprocessed process stream by a means of phase separation, and optionally cooling, to provide a multiple-phase combined stream,
c. separating said multiple-phase combined stream in at least a hydrogen rich gas stream comprising a majority of the hydrogen comprised in said hydroprocessed process stream and a rich liquid hydrocarbon stream comprising absorbed methane,
d. in a desorption step, desorbing an amount of methane from said rich liquid hydrocarbon stream, in order to transfer an amount of methane to the gas phase, in order to provide a methane rich gaseous stream, and in order to provide a liquid product stream of hydrocarbons.

2. The process according to claim 1, wherein said methane lean stream of hydrocarbons is combined with the two-phase hydroprocessed process stream to provide said multiple-phase combined stream, prior to cooling and phase separation of the combined stream to provide said hydrogen rich gas stream and said rich liquid hydrocarbon stream.

3. The process according to claim 1, wherein the two-phase hydroprocessed process stream is cooled, and phase separated by a flashing step, to provide a gas stream and a liquid stream and wherein the methane lean stream of hydrocarbons is combined in a combining step with the gas stream to provide said multiple-phase combined stream.

4. The process according to claim 3, wherein the flashing step as well as the combining step are made in an integrated absorption zone and flashing zone, such that the methane lean stream of hydrocarbons is combined with the two-phase hydroprocessed hydrocarbon stream to provide said stream rich liquid stream of hydrocarbons comprising the methane.

5. A The process according to claim 3, wherein the flashing step as well as the combining step are carried out in separate devices for flash separation and absorption.

6. The process according to claim 1 wherein separating said two-phase hydroprocessed process stream, is carried out, after optional cooling, by directing the two-phase hydroprocessed process stream to a high pressure stripper receiving a stripping medium, and providing a stripped liquid stream and a stripper overhead stream.

7. The process according to claim 6 wherein said stripper overhead stream constitutes the gaseous hydroprocessed stream, which is combined with a methane lean stream of hydrocarbons prior to being directed to a first separator, providing at least said methane enriched liquid stream of hydrocarbons and said hydrogen rich gaseous stream, and in which said methane rich liquid stream is directed to a further separator providing said desorption step, to provide a methane reduced liquid stream and the methane rich gaseous stream.

8. The process according to claim 1, wherein the pressure of the multiple phase combined stream is at least 3000 kPa.

9. The process according to claim 1, wherein the temperature of the multiple phase combined stream is from 20° C. to 275ºC, such as from 20° C. to 90° C. or 150° C. or from 150° C. or 200° C. to 275° C.

10. The process according to claim 1, wherein the desorption step comprises decreasing the pressure to less than 2000 kPa.

11. The process according to claim 1, wherein the desorption step comprises stripping the methane enriched liquid stream of hydrocarbons with a stripping medium, such as hydrogen or steam.

12. The process according to claim 1, wherein the desorption step involves a decrease of pressure by 80% of the pressure before desorption.

13. The process according to claim 1, wherein the liquid product stream of hydrocarbons comprises at least an amount of the methane reduced liquid stream or a product of further hydroprocessing of the methane reduced liquid stream.

14. The process according to claim 1, wherein the liquid stream of hydrocarbons comprises at least an amount of the liquid hydroprocessed stream or a product of further hydroprocessing of the liquid hydroprocessed stream.

15. A process plant comprising
a hydroprocessing section having a liquid phase inlet, a gas phase inlet and an outlet,
a first means of separation having an inlet, a liquid phase outlet and a gas phase outlet,
a means of absorption, having a liquid inlet and a gas phase inlet, a liquid phase outlet and a gas phase outlet, optionally in an integrated device in the same pressure vessel as said first means of separation such that by the gas phase outlet of the first means of separation, the gas phase inlet of the means of absorption and the liquid phase outlet of the means of absorption are internal to the integrated device,
a second means of separation having an inlet, a liquid phase outlet and a gas phase outlet,
wherein the liquid phase inlet of the hydroprocessing section is configured to receive an oxygenate feedstock,
the gas phase inlet of the hydroprocessing section is configured to receive a gas rich in hydrogen, and the outlet of the hydroprocessing section is in fluid communication with the inlet of the first means of separation,
the gas phase outlet of the first means of separation is in fluid communication with the gas phase inlet of the means of absorption,
a liquid hydrocarbon stream is directed to said liquid phase inlet of the means of absorption and
the gas phase outlet of the means of absorption is in fluid communication with said gas phase inlet of the hydroprocessing section, optionally via a means of purification,
the liquid phase outlet of the means of absorption is in fluid communication with the inlet of said second means of separation.

16. The process plant according to claim 15, further comprising a means of pressurization having an inlet and an outlet, wherein the liquid phase outlet of said second means of separation is in fluid communication with the inlet of said means of pressurization, and the outlet of said means of pressurization is in fluid communication with the inlet of said means of absorption.)

17. An integrated means of separation and absorption comprising a multiple phase stream inlet, a liquid phase inlet, a liquid phase outlet and a gas phase outlet,
said integrated means of separation and absorption comprising a separation zone and an absorption zone in a single pressure vessel,
wherein said separation zone is positioned below said absorption zone and configured to allow fluid communication between the separation zone and the absorption zone, and
wherein said absorption zone, has a liquid inlet and a gas phase outlet, and optionally comprises means for enhancing the contact between gas and liquid.
